(19) United States
(12) Patent Application Publication
(10) Pub. No.: US 2021/0021804 A1
(43) Pub. Date: Jan. 21, 2021

(54) METHOD FOR DISPLAYING STEREOSCOPIC IMAGE AND STEREOSCOPIC IMAGE DISPLAY APPARATUS

(71) Applicant: CHERAY CO. LTD., HSINCHU CITY (TW)

(72) Inventors: CHUN-HSIANG YANG, HSINCHU CITY (TW); YI-PAI HUANG, HSINCHU CITY (TW); JUI-YI WU, MIAOLI COUNTY (TW); CHI-KUANG LAI, TAOYUAN CITY (TW); CHIH-HUNG TING, NEW TAIPEI CITY (TW)

(21) Appl. No.: 17/065,077

(22) Filed: Oct. 7, 2020

Related U.S. Application Data
(63) Continuation-in-part of application No. 15/658,059, filed on Jul. 24, 2017.

(30) Foreign Application Priority Data
Aug. 10, 2016 (TW) 105125432

(51) Int. Cl. H04N 13/383; H04N 13/307; G02B 30/27; G02B 30/56

(52) U.S. Cl. CPC H04N 13/383; G02B 30/56; G02B 30/27; H04N 13/307

(57) ABSTRACT

A method for displaying a stereoscopic image and a stereoscopic image display apparatus are provided. The method includes: providing a stereoscopic image display apparatus including an image display device and a lens array layer, the image display device having a display surface and an image calculation unit, and the lens array layer including a plurality of lens units; using the image calculation unit to create a reference stereoscopic image; obtaining a viewing angle information; calculating a plurality of unit images displayed on the display surface from the reference stereoscopic image according to the viewing angle information; and recombining the unit images to produce a stereoscopic image. When the viewing angle of the user changes, the viewing angle information will be correspondingly changed, and the image calculation unit will change display contents of the unit images according to the changed viewing angle information.

### CROSS-REFERENCE TO RELATED PATENT APPLICATION

This application is a continuation-in-part application of U.S. application Ser. No. 15/658,059, filed on Jul. 24, 2017 and entitled “IMAGE DISPLAY APPARATUS FOR DISPLAYING STEREO IMAGE AND IMAGE DISPLAY METHOD THEREOF”, now pending.

### BACKGROUND OF THE INVENTION

### Field of the Invention

The present disclosure relates to a method for displaying an image; in particularly to, a method for displaying a stereoscopic image and a stereoscopic image display apparatus.

### Description of Related Art

Generally, conventional three dimensional image display devices mainly employ the binocular vision fusion imaging technology. Regarding to these kinds of image display devices, the user has to view the stereo image at a straight angle of view, or the image depth cannot be too far away from a display surface of the display device. When three dimensional image display using in such as aviation terrain models, building models, and 3D medical training devices, the all device is placed horizontally, but the oblique angle of view is natural to the user. However, conventional three dimensional image display devices are incapable of providing a natural angle of view, thus inconveniencing to the user. Moreover, conventional three dimensional image display devices provide the user with visual stimuli in only one direction, i.e., either with the image advancing forward, or withdrawing backward. Therefore, conventional three dimensional image display devices cannot provide a vivid sensation that the image is escaping the confines of the plane of the display surface and floating in mid-air.

In this regard, the present disclosure provides a method for displaying a stereoscopic image and a stereoscopic image display apparatus to overcome the aforementioned drawbacks.

### SUMMARY OF THE INVENTION

The present disclosure provides a method for displaying a stereoscopic image and a stereoscopic image display apparatus.

To resolve the above technical problems, the present disclosure provides a method for displaying a stereoscopic image, including: providing a stereoscopic image display apparatus, in which the stereoscopic image display apparatus includes an image display device and a lens array layer, the image display device has a display surface and an image calculation unit, the lens array layer is disposed on the display surface of the image display device, and the lens array layer includes a plurality of lens units; using the image calculation unit to receive a stereoscopic image information, and to create a reference stereoscopic image according to the stereoscopic image information, in which the reference stereoscopic image is configured to reflect the stereoscopic image that is finally produced; using the image calculation unit to obtain a viewing angle information according to a viewing angle of a user, and to calculate a plurality of unit images that correspond in position to the plurality of lens units from the reference stereoscopic image according to the viewing angle information, in which the plurality of unit images are displayed on the display surface of the image display device; recombining the plurality of unit images into an integral image through the plurality of lens units, so as to finally produce the stereoscopic image. When the viewing angle of the user changes, the viewing angle information obtained by the image calculation unit will correspondingly change, and the image calculation unit will change display contents of the plurality of unit images according to the changed viewing angle information, so that the finally produced stereoscopic image will be correspondingly changed.

The present disclosure also provides a stereoscopic image display apparatus which includes an image display device and a lens array layer. The image display device has a display surface and an image calculation unit. The lens array layer is disposed on the display surface of the image display device, and the lens array layer includes a plurality of lens units. The image calculation unit of the image display device is configured to execute the method for displaying the stereoscopic image as described above.

The present disclosure has at least the following advantages.

In terms of hardware, the image display apparatus of the present disclosure requires only an image display device and a lens array layer to achieve the floating stereo image without using other optical films, thereby providing a relative simple structure. The image display method of the present disclosure, which is different from the general integrated image calculation algorithms, can be applied to an oblique angle of view, and can provide the calculated image corresponding to a particular angle.

The main concept of the floating stereo image is allowing the user to receive the sensation of a vivid floating effect. The oblique angle of view in the image display method can be used to facilitate the user to confirm the corresponding depth and position of the image in the space so as to achieve the floating effect.

In order to further the understanding of the present disclosure, the following embodiments are provided along with illustrations to facilitate the disclosure of the present disclosure.

### BRIEF DESCRIPTION OF THE DRAWINGS

FIG. 1 is a perspective view of an image display apparatus according to a first embodiment of the present disclosure;

FIG. 2 is a planar view of the image display apparatus which provides a vertical angle of view to a user according to the first embodiment of the present disclosure;

FIG. 3 is a planar view of the image display apparatus which provides an oblique angle of view to the user according to the first embodiment of the present disclosure;

FIG. 4 is a planar view of the image display apparatus which provides another oblique angle of view to the user according to the first embodiment of the present disclosure;

FIG. 5 is a flow chart of an image display method according to a second embodiment of the present disclosure;

FIG. 6 is a schematic diagram of an image display apparatus controlled by an algorithm according to the second embodiment of the present disclosure;

FIG. 7 is a planar view of a lens array layer arranged in an aligned arrangement in the image display apparatus according to a third embodiment of the present disclosure;

FIG. 8 is a planar view of the lens array layer arranged in an staggered arrangement in the image display apparatus according to the third embodiment of the present disclosure;

FIG. 9 is a schematic view of a single lens which is focusing light in the image display apparatus according to the third embodiment of the present disclosure;

FIG. 10 is a schematic view showing a usage state of the image display apparatus according to a fourth embodiment of the present disclosure;

FIG. 11 is a perspective view of a lens array layer having columnar structure in the image display apparatus according to a fifth embodiment of the present disclosure; and

FIG. 12 is a schematic planar view of the lens array layer having columnar structure in the image display apparatus according to the fifth embodiment of the present disclosure.

FIG. 13 is a schematic view of a frontal viewing angle of the stereoscopic image display apparatus according to a seventh embodiment of the present disclosure.

FIG. 14 is a schematic view of an oblique viewing angle of the stereoscopic image display apparatus according to the seventh embodiment of the present disclosure.

FIG. 15 is a schematic view (I) of the stereoscopic image display apparatus including an optical light guide element according to the seventh embodiment of the present disclosure.

FIG. 16 is a schematic view (II) of the stereoscopic image display apparatus including the optical light guide element according to the seventh embodiment of the present disclosure.

FIG. 17 is a schematic view (III) of the stereoscopic image display apparatus including the optical light guide element according to the seventh embodiment of the present disclosure.

FIG. 18 is a schematic view of the stereoscopic image display apparatus including the optical light guide element and an eye tracking unit according to the seventh embodiment of the present disclosure.

### DETAILED DESCRIPTION OF PREFERRED EMBODIMENTS

The aforementioned illustrations and following detailed descriptions are exemplary for the purpose of further explaining the scope of the instant disclosure. Other objectives and advantages related to the instant disclosure will be illustrated in the subsequent descriptions and appended drawings. In addition, for an easy instruction, similar reference numbers or symbols refer to elements alike.

### First Embodiment

The present disclosure provides an image display apparatus, which can be used in industries such as optoelectronics, medical, military, exhibition, display, education, entertainment, and consumer electronics. The image display apparatus can be used in active and passive three dimensional stereoscopic display apparatus, but is not limited thereto.

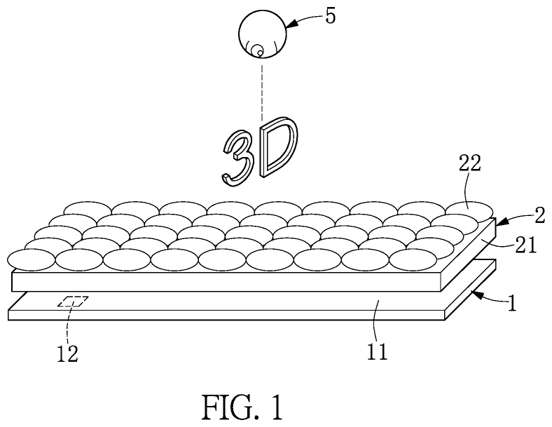

Referring to FIG. 1, the image display apparatus includes an image display device 1 and a lens array layer 2. The image display apparatus can alter a stereo image that the user sees by altering a displayed image, and allows the user to see the stereo image at different angles of view. The image display apparatus of the present disclosure is a two-layer structure, which can be placed on tables, walls, ceilings, or any planes.

The image display device 1 includes a display surface 11 for displaying an image. The lens array layer 2 is disposed on the display surface 11 of the image display device 1, in other words, the lens array layer 2 is disposed above the image display device 1. The lens array layer 2 can be arranged in contact with the display surface 11 of the image display device 1. The lens array layer 2 can be arranged spaced apart from the display surface 11 of the image display device 1. In addition, a spacer can be disposed between the display surface 11 of the image display device 1 and the lens array layer 2.

The image display device 1 is located at a first layer (i.e., a bottom layer) of the image display apparatus, and is configured to display an un-reconstruction planar image that has not been reproduced. The planar image can be reconstructed as an integrated image by the lens array of the lens array layer 2, so that a stereo image can be reproduced. Moreover, the image display device 1 disposed on the first layer is configured to display a target image. Therefore, the image display device 1 in the present disclosure can be any types of hardware including, but not limited to, a mobile phone, a tablet, a flat panel display, a printed image, an engraved image, or a projection display image.

The lens array layer 2 is located at a second layer (i.e., a top layer) of the image display apparatus, and has the ability to control the light field. The lens array layer 2 can be configured to control the angle of light of the three dimensional object, and can be configured to reconstruct the un-reconstruction planar image on the display surface 11, thereby allowing the user 5 to see a stereo image. The curvature of each lens 22 of the lens array layer 2 is determined by the material thereof. The curvatures of the lenses 22 of the lens array layer 2 as well as the combination of the lenses 22 and the image display device 1 located at the first layer determine the height, the range of angle of view, and the clarity of the stereo image.

In the present embodiment, the lens array layer 2 is made of a material with good optical characteristics, which includes, but is not limited to, polymethylmethacrylate (PMMA), polycarbonate (PC), polyethylene (PE), glass and other light-transmission materials. The lens array layer 2 includes a base 21 and a plurality of lenses 22. The lenses 22 are disposed on a surface of the base 21, in other words, the lenses 22 are disposed on a surface of the base 21 away from the image display device 1. Moreover, the lenses 22 have the ability to focus light. It should be noted that the arrangement and the structure of the lens array layer 2 are not limited to the present embodiment.

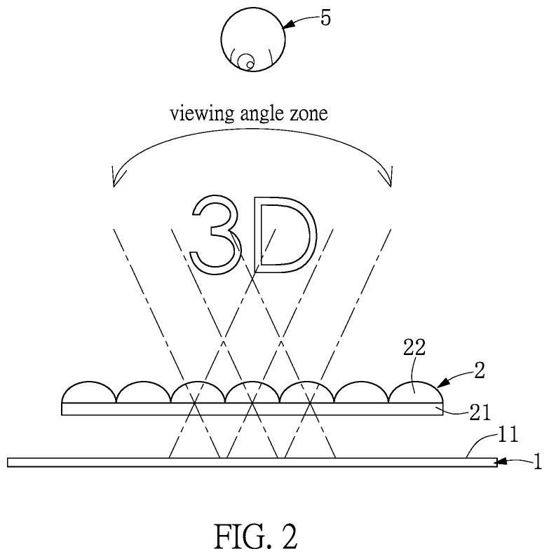

There exist drawbacks of angle of view in most of the conventional naked-eye three dimensional image display apparatuses so that the user 5 cannot see the stereo image at an oblique angle of view. The main feature of the present disclosure is that the user 5 can see the stereo image at an oblique angle of view, although the user 5 is not in front of the image display device 1. Referring to FIG. 2, when the user 5 is in front of the image display device 1 (i.e., zero order viewing zone), the image display device 1 has a limited viewing angle zone for the user 5. Once the user's sight is out of the viewing angle zone, the user 5 will not see the correct stereo image.

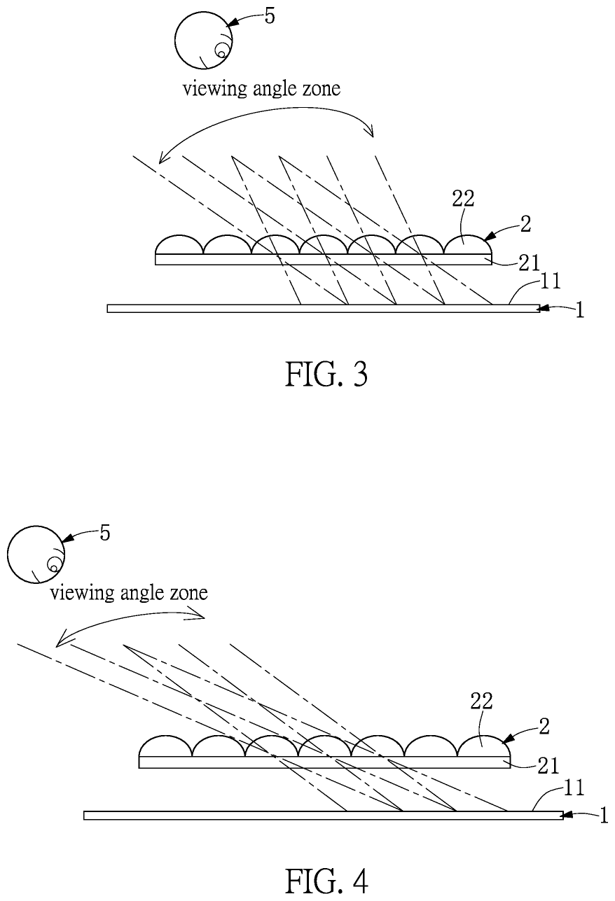

In order to allow the user 5 to see the stereo image at an oblique angle of view, the present embodiment employs the displaying method as shown in FIG. 3 and FIG. 4, using an oblique angle image display method instead of a zero order (forward) image display method. That is, the path of the lights will be converged in an oblique direction, so that the user 5 can see the stereo image at the oblique angle of view. FIG. 3 and FIG. 4 are the viewing zones, which are set to the first order viewing zone and the second order viewing zone respectively. That is, the larger the oblique angle of view is, the larger the order of the viewing zone is. Thus the viewing zone can be set to a third order viewing zone, a fourth order viewing zone, or a higher order viewing zone. At the same time, the un-reconstruction planar image also needs to be adjusted accordingly. The corresponding algorithm will be described in the second embodiment. With the image of the same order, the user 5 can see the stereo image at the corresponding oblique angle of view. The oblique angle image display method in the present disclosure can be applied to various special occasions. For example, when the image display device 1 needs to be hidden, or when the user 5 is viewing the stereo image at a non-vertical angle of view.

### Second Embodiment

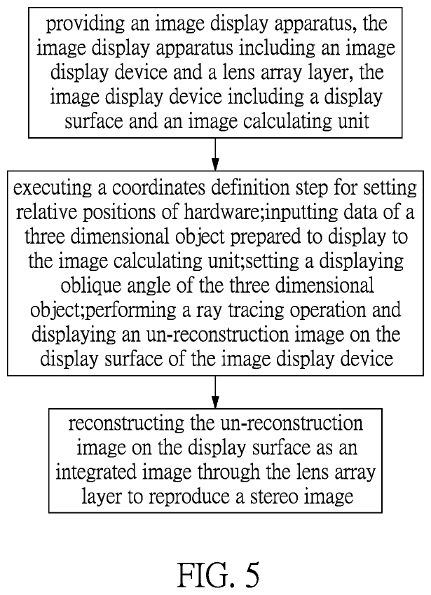

The image display device 1 in the present disclosure can be any specification as long as it can be applied to an image algorithm. In other words, the image display device 1 includes an image calculation unit 12 including an image algorithm. The image used in the image display device 1 is calculated by the image algorithm. This calculation is matched to the configuration of the lens array layer 2, which predicts the various possible paths of the light, thereby calculating the relative position of the image. FIG. 5 is a flowchart of an image display method of the present disclosure, which comprises the following steps.

Firstly, providing an image display apparatus. The image display apparatus includes an image display device 1 and a lens array layer 2 (as shown in FIG. 1). The image display device 1 includes a display surface 11 and an image calculation unit 12. The lens array layer 2 is disposed on the display surface 11 of the image display device 1. The lens array layer 2 includes a base 21 and a plurality of lenses 22. The lenses 22 are disposed on a surface of the base 21.

Secondly, executing a coordinate definition step for setting relative positions of hardware which includes a relative position of each of the lenses 22 of the lens array layer 2, a distance between the lens array layer 2 and the image display device 1, and a pixel size match; inputting data of a three dimensional object prepared to display to the image calculation unit 12; setting a displaying oblique angle of the three dimensional object; and performing a ray tracing operation and displaying an un-reconstruction image on the display surface 11 of the image display device 1.

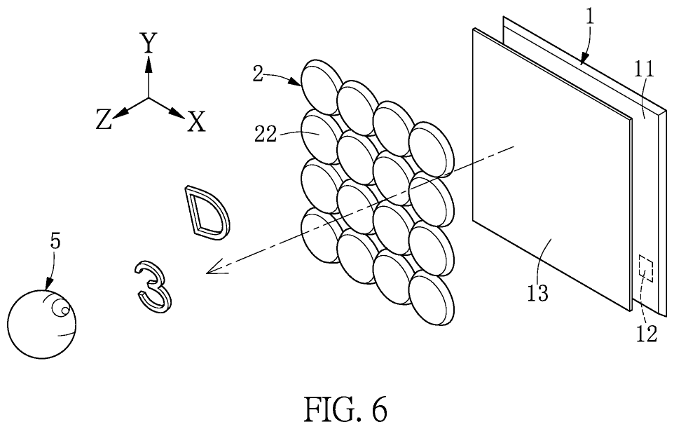

Finally, referring to FIG. 6, reconstructing the calculated un-reconstruction image on the display surface 11 as an integrated image 13 through the lens array layer 2 to reproduce a stereo image. Since the angle of view is oblique, the calculated un-reconstruction image will be slightly different. Referring to FIGS. 2 to 4, the three dimensional objects respectively shown in the three figures are the same object, but since the angles of view are different, the image algorithm needs to match the settings of the different displaying angles, resulting in that the calculated un-reconstruction image will be slightly different. With a two-layer structure of the image display device 1 of the present disclosure, lights can be transmitted from the image display device 1 and be re-converged into a stereo image in mid-air through the lens array layer 2 so as to conform to an ergonomic angle of view.

### Third Embodiment

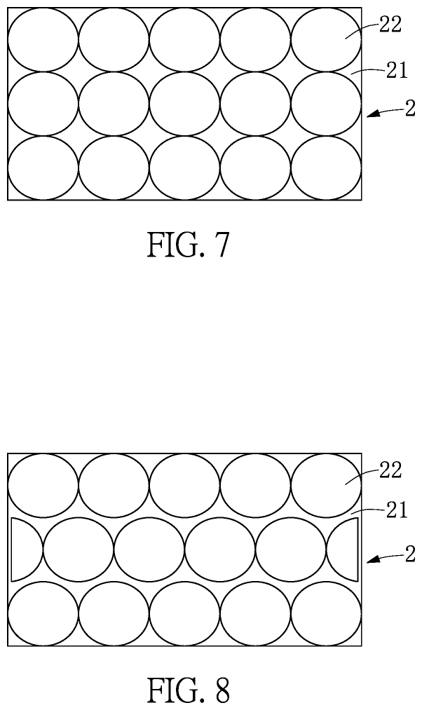

The lens array layer 2 of the present disclosure has a significant correlation to the display effect. Referring to FIG. 7 and FIG. 8, the lens array layers 2 can be arranged in a rectangular arrangement or a hexagonal arrangement, that is, the lenses 22 in each two adjacent columns are arranged in an aligned arrangement (FIG. 7) or a staggered arrangement (FIG. 8). Further, each of the arrangements can be used to produce a stereo image.

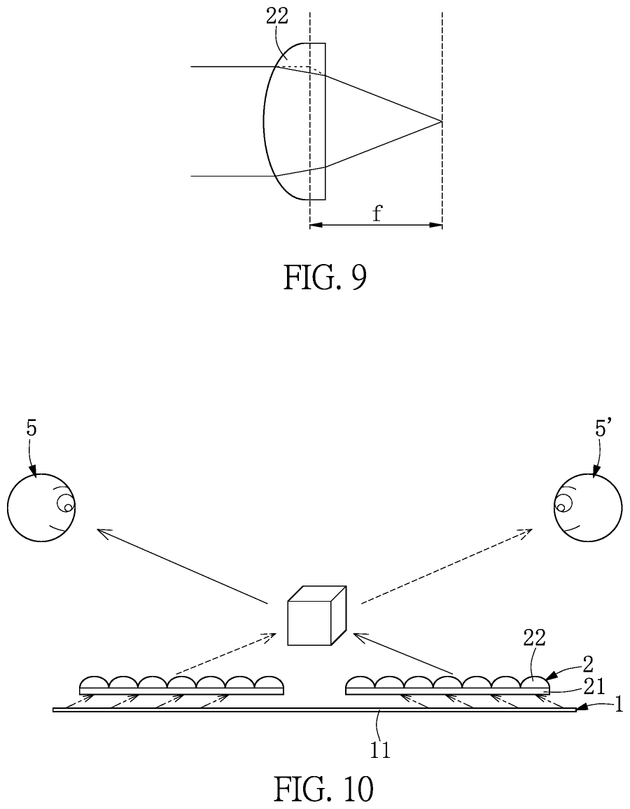

The microstructures on the lens array layer 2 are the lenses 22 having the light focusing function. The light focusing ability of each lens 22 can be determined according to the refractive index (n value) of its material. Each of the lenses 22 transmits light having a wavelength range of 300 nm to 1100 nm. Each of the lenses 22 conforms to Lensmaker's equation (FIG. 9): 1/f=(n−1)(1/R1+1/R2), in which R1 and R2 are the respective radiuses of curvature of bilateral surfaces of the lens 22, f is the focal length of the lens 22, and n is the refractive index of the lens 22. In addition, each of the lenses 22 has a diameter of 100 um to 5 mm, which is adapted to the pixel size of different display devices.

### Fourth Embodiment

Referring to FIG. 10, the present embodiment provides an application of the image display apparatus in an oblique angle of view. At both sides of the image display device 1, users 5, 5′ can see the image data from the opposite side respectively. The image display device 1 can be configured to use a directional backlight module to cooperate with the calculated un-reconstruction image for providing front and back images of the same three dimensional object to the users 5, 5′ at both sides of the image display device 1 respectively, so as to achieve the purpose of multi-angle of views for multiple users. The use of directional backlight module is to provide a specific angle of light, to avoid excessive divergence angle, and to avoid the image interference. The calculated un-reconstruction image needs to pre-calculate the stereo image display area corresponding to the provided angle. This approach can solve the problem of insufficient angle of view of conventional naked-eye image display devices.

### Fifth Embodiment

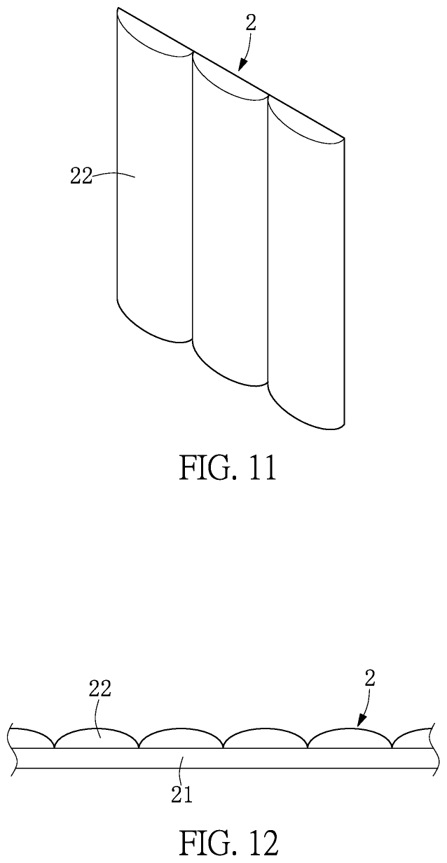

Referring to FIGS. 11 and 12, the lenses 22 of the lens array layer 2 have columnar structures, that is, the lenses 22 are columnar lenses. Accordingly, the lenses 22 have the lens characteristics only in one-dimensional orientation (not in another-dimensional orientation).

### Sixth Embodiment

The image display device 1 of the present disclosure can be a stereoscopic image display device with a human eye tracking function. The image display device 1 according to the present embodiment of the present disclosure can give a user 5 a greater angle of view, and is capable of tracking a position of a user's eye in a screen by a sensing element, calculating an oblique angle of view of the user 5 with respect to the image display device 1 according to the position, and providing a suitable un-reconstruction image relative to the oblique angle of view so as to reproduce the stereo image when the user's eye is moving. Accordingly, it is possible to give the corresponding stereo image according to the movement of the user's position and solve the problem of insufficient angle of view of conventional naked-eye image display devices.

The present disclosure provides an image display apparatus and an image display method thereof which can be applied to an oblique angle of view. The image display apparatus, in conjunction with the hardware arrangement, controls the direction of lights emitted from each pixel in the image display device through the optical element. The hardware system of the present disclosure includes simple optical elements, such as an image display device and a lens array layer, which can be packaged as a kit. Also, the hardware system can be configured to display the realistic stereo image in mid-air by the designed pixel size, system gap, lens size and focal length, and by using the integrated image principle to match the screen output signal calculated by the particular algorithm.

In terms of hardware, the image display apparatus of the present disclosure requires only an image display device and a lens array layer to achieve the floating stereo image without using other optical films, thereby providing a relative simple structure. The image display method of the present disclosure, which is different from the general integrated image calculation algorithms, can be applied to an oblique angle of view, and can provide the calculated image corresponding to a particular angle.

### Seventh Embodiment

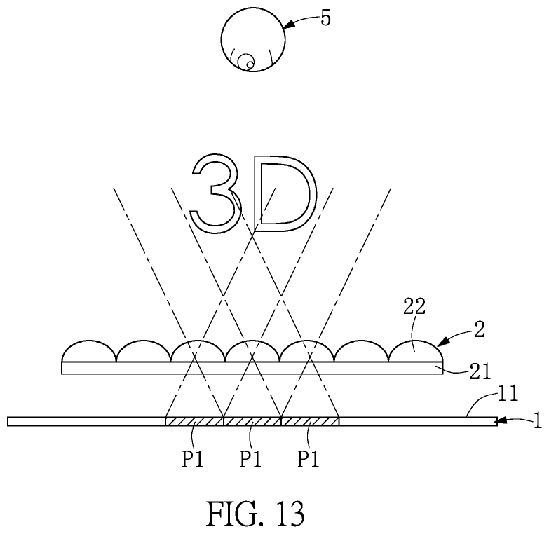

As shown in FIG. 13 to FIG. 16, a seventh embodiment of the present disclosure provides a method for displaying a stereoscopic image. The method for displaying the stereoscopic image is configured to calculate contents of unit images displayed on a display surface of an image display device through an algorithm according to a viewing angle of a user. The method for displaying the stereoscopic image includes steps of S110 to S140. It should be noted that the order of the steps and the actual operation way described in the present embodiment may be adjusted according to requirements and are not limited to those described in the present embodiment.

As shown in FIG. 1 and FIG. 13, the step S110 includes: providing a stereoscopic image display apparatus. The stereoscopic image display apparatus includes: an image display device 1 and a lens array layer 2. The image display device 1 has a display surface 11 and an image calculation unit 12. The lens array layer 2 is disposed on the display surface 11 of the image display device 1, and the lens array layer 2 includes a base portion 21 and a plurality of lens units 22 disposed on the base portion 21.

In the present embodiment, the plurality of lens units 22 are arranged in a matrix, and the plurality of lens units 22 are arranged on a side surface of the base portion 21 away from the image display device 1. Each of the lens units 22 is a single lens, but the present disclosure is not limited thereto. For example, each of the lens units 22 may also be a lens group composed of a plurality of lenses. The plurality of lens units 22 of the lens array layer 2 are configured to converge and recombine the unit images displayed on the display surface of the image display device to produce a stereoscopic image.

The step S120 includes: using the image calculation unit 12 of the image display device 1 to receive a stereoscopic image information. In addition, the image calculation unit 12 is configured to create a reference stereoscopic image according to the stereoscopic image information, and the reference stereoscopic image is capable of reflecting the stereoscopic image that is finally produced.

The stereoscopic image information includes: a color information and a three-dimensional space information of a stereoscopic image. Further, the stereoscopic image information may also, for example, include a set of a coordinate value and a chromaticity value that describes the stereoscopic image.

In addition, the reference stereoscopic image has full three-dimensional object information of the stereoscopic image, such as the information of all viewing angles of a three-dimensional object. In addition, the reference stereoscopic image may be a static three-dimensional object information, or a continuous dynamic three-dimensional object information, and the present disclosure is not limited thereto.

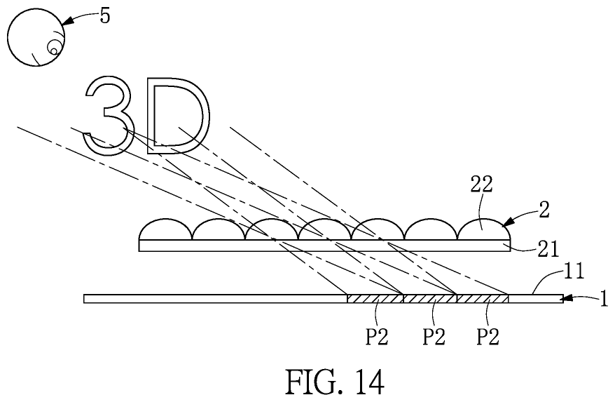

As shown in FIG. 13 and FIG. 14, the step S130 includes: using the image calculation unit 12 of the image display device 1 to obtain a viewing angle information according to a viewing angle of a user 5. In addition, the image calculation unit 12 is configured to calculate a plurality of unit images P1 or P2 that correspond in position to the plurality of lens units 22 from the reference stereoscopic image according to the viewing angle information. The plurality of unit images P1 or P2 are displayed on the display surface 11 of the image display device 1 to provide the image display device 1 to display an integral image.

It is worth mentioning that in the present embodiment, each of the unit images P1 or P2 corresponds to one lens unit 22, so that each of the unit images P1 or P2 can be light converged through a corresponding one of the lens units 22.

As shown in FIG. 13 and FIG. 14, the step S140 includes: recombining the plurality of unit images P1 or P2 into an integral image through the plurality of lens units 22, so as to finally produce the stereoscopic image, such as the 3D words shown in FIG. 13 and FIG. 14.

Furthermore, when the viewing angle of the user 5 changes, the viewing angle information obtained by the image calculation unit 12 of the image display device 1 will correspondingly change, and the image calculation unit 12 will change display contents of the plurality of unit images P1 or P2 according to the changed viewing angle information, so that the finally produced stereoscopic image will be correspondingly changed. In other words, the display contents of the unit images P1 and the unit images P2 are different from each other.

More specifically, as shown in FIG. 13, when the viewing angle of the user 5 is at a first viewing angle (i.e., a frontal viewing angle), the viewing angle information obtained by the image calculation unit 12 is defined as a first viewing angle information, and the image calculation unit 12 is configured to calculate a plurality of first unit images P1 from at least a part of the display contents of the reference stereoscopic image according to the first viewing angle information (i.e., the display content of a three-dimensional object according to the first viewing angle).

Furthermore, the plurality of first unit images P1 respectively correspond in position to the plurality of lens units 22, and the plurality of lens units 22 can recombine the plurality of first unit images P1 into a first integral image to form a first stereoscopic image (as shown in FIG. 13).

As shown in FIG. 14, when the viewing angle of the user 5 is at a second viewing angle (i.e., an oblique viewing angle) that is different from the first viewing angle, the viewing angle information obtained by the image calculation unit 12 is defined as a second viewing angle information, and the image calculation unit 12 is configured to calculate a plurality of second unit images P2 from at least another part of the display contents of the reference stereoscopic image according to the second viewing angle information (i.e., the display content of the three-dimensional object according to the second viewing angle).

Furthermore, the plurality of second unit images P2 respectively correspond in position to the plurality of lens units 22, and the plurality of lens units 22 can recombine the plurality of second unit images P2 into a second integral image to form a second stereoscopic image (as shown in FIG. 14).

In an embodiment of the present disclosure, the plurality of first unit images P1 and the plurality of second unit images P2 are all displayed on the display surface 11 of the image display device 1, and the display positions of the plurality of second unit images P2 (as shown in FIG. 14) on the display surface 11 are shifted by a predetermined distance relative to that of the plurality of first unit images P1 (as shown in FIG. 13). In addition, in each of the second unit images P2 and the corresponding first unit image P1, a display content of the second unit image P2 is different from that of the first unit image P1.

In an embodiment of the present disclosure, the viewing angle of the user 5 is defined by an angle between a line of sight of the user 5 and a normal vector of the stereoscopic image display apparatus. When the second viewing angle of the user is oblique relative to the first viewing angle, a value of the second viewing angle information will be greater than that of the first viewing angle information, and the positions of the plurality of second unit images P2 on the display surface 11 of the image display device 1 are shifted in a direction away from the user 5 relative to that of the plurality of first unit images P1.

In an embodiment of the present disclosure, when the viewing angle of the user 5 is at the first viewing angle, the plurality of first unit images P1 calculated by the image calculation unit 12 are further generated by ray tracing, and each of the first unit images P1 has a first ray tracing angle information. Moreover, when the viewing angle of the user 5 is at the second viewing angle, the plurality of second unit images P2 calculated by the image calculation unit 12 are also generated by the ray tracing, and each of the second unit images P2 has a second ray tracing angle information.

It should be noted that the above-mentioned ray tracing refers to an algorithm that traces the light paths of rays from different angles. That is, the first ray tracing angle information is generated by the image calculation unit 12 tracing the light path from the line of sight of the user 5 when the user 5 is at the first viewing angle. In addition, the second ray tracing angle information is generated by the image calculation unit 12 tracing the light path from the line of sight of the user 5 when the user 5 is at the second viewing angle.

In an embodiment of the present disclosure, the first ray tracing angle information corresponds to the first viewing angle information, the second ray tracing angle information corresponds to the second viewing angle information, and the first ray tracing angle information is different from the second ray tracing angle information.

In an embodiment of the present disclosure, in each of the first unit images P1 and the corresponding second unit image P2, the first unit image P1 is light converged by one of the lens units 22 among the plurality of lens units 22, and the second unit image P2 is light converged by the same lens unit 22 as that of the first unit image P1.

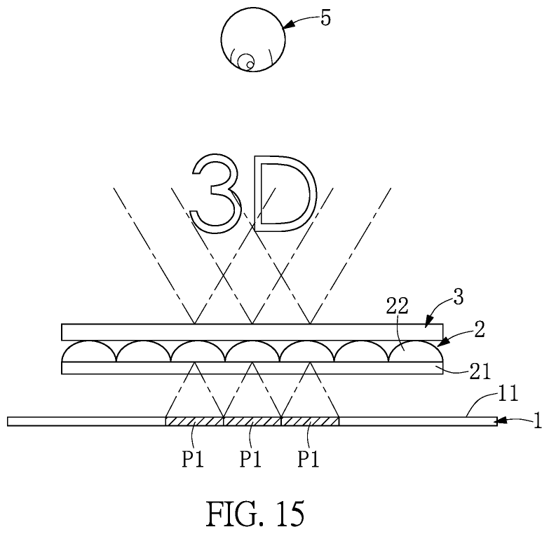

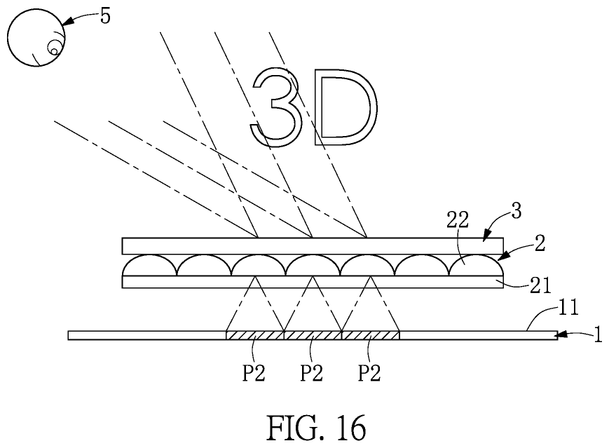

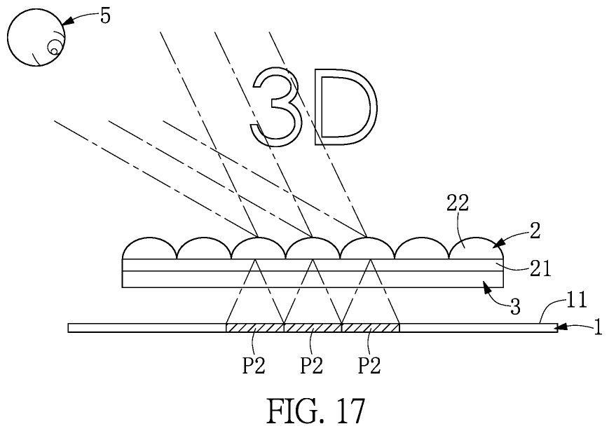

As shown in FIG. 15 to FIG. 17, in an embodiment of the present disclosure, the stereoscopic image display apparatus further includes an optical light guide element 3, the optical light guide element 3 is arranged on a side of the lens array layer 2 away from the image display device 1 (as shown in FIGS. 15 and 16) or is arranged on a side of the lens array layer 2 adjacent to the image display device 1 (as shown in FIG. 17), and the optical light guide element 3 is configured to guide light paths of the plurality of first unit images P1 or the plurality of second unit images P2, so that a first stereoscopic image (the 3D words as shown in FIG. 15) generated by the plurality of first unit images P1 and a second stereoscopic image (the 3D words as shown in FIG. 16) generated by the plurality of second unit images P2 are displayed at the same position in a three-dimensional space above the stereoscopic image display apparatus. It is worth mentioning that the optical light guide element 3 may be, for example, a light guide plate, a refraction plate, or a polarizing plate, but the present disclosure is not limited thereto.

In the case where the above-mentioned stereoscopic image display apparatus includes the optical light guide element 3, the plurality of first unit images P1 and the plurality of second unit images P2 are all displayed on the display surface 11 of image display device 1, and the display positions of the plurality of second unit images P2 on the display surface 11 (as shown in FIG. 16) are the same as the display positions of the plurality of first unit images P1 on the display surface 11 (as shown in FIG. 15). In each of the second unit images P2 and the corresponding first unit images P1, the display content of the second unit image P2 is different from the display content of the first unit image P1.

Furthermore, the viewing angle of the user 5 is defined by an angle between a line of sight of the user 5 and a normal vector of the stereoscopic image display apparatus. When the second viewing angle of the user is oblique relative to the first viewing angle, a value of the second viewing angle information will be greater than that of the first viewing angle information. In addition, the display positions of the plurality of second unit images P2 on the display surface 11 (as shown in FIG. 16) are the same as the display positions of the plurality of first unit images P1 on the display surface 11 (as shown in FIG. 15), and the light paths of the plurality of second unit images P2 and the light paths of the plurality of first unit images P1 are all directed toward the plurality of lens units 22 along the normal vector of the stereoscopic image display apparatus. Further, the optical light guide element 3 is configured to deflect the light paths of the plurality of second unit images P2 toward the user 5 (as shown in FIG. 16).

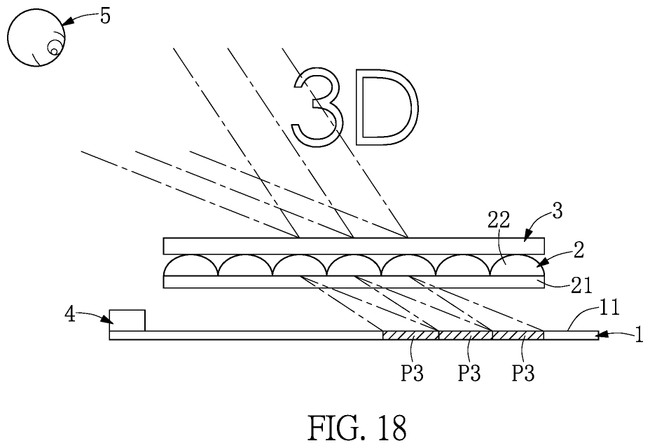

As shown in FIG. 18, the stereoscopic image display apparatus further includes an eye tracking unit 4. The eye tracking unit 4 is configured to track the eye position of the user 5. When the viewing angle of the user 5 is located at a second viewing angle that is different from the first viewing angle, the viewing angle information obtained by the image calculation unit 12 is defined as a second viewing angle information. The image calculation unit 12 is configured to calculate a plurality of third unit images P3 from at least another part of the contents of the reference stereoscopic image according to the second viewing angle information.

Furthermore, the plurality of first unit images P1 and the plurality of third unit images P3 are all displayed on the display surface 11 of the image display device 1. The positions of the plurality of third unit images P3 on the display surface 11 are shifted relative to the plurality of first unit images P1. In each of the third unit image P3 and the corresponding first unit image P1, the display content of the third unit image P3 is different from the display content of the first unit image P1. Moreover, the display content of the third unit image P3 is also different from the display content of the second unit image P2.

According to the above configuration, the method for displaying the stereoscopic image can adjust the display content of the stereoscopic image through an algorithm according to the viewing angle of the user 5, so that the user 5 can view a suitable stereoscopic image.

### Eighth Embodiment

The eighth embodiment of the present disclosure provides a stereoscopic image display apparatus. The stereoscopic image display apparatus includes: an image display device 1 and a lens array layer 2. The image display device 1 has a display surface 11 and an image calculation unit 12, and the lens array layer 2 is disposed on the display surface 11 of the image display device 1. The lens array layer 2 includes a base portion 21 and a plurality of lens units 22 disposed on the base portion 21. The image calculation unit 12 of the image display device 1 is configured to execute the method for displaying the stereoscopic image as described in the seventh embodiment.

The descriptions illustrated supra set sixth simply the preferred embodiments of the present disclosure; however, the characteristics of the present disclosure are by no means restricted thereto. All changes, alterations, or modifications conveniently considered by those skilled in the art are deemed to be encompassed within the scope of the present disclosure delineated by the following claims.

What is claimed is:

1. A method for displaying a stereoscopic image, comprising:
providing a stereoscopic image display apparatus; wherein the stereoscopic image display apparatus includes an image display device and a lens array layer, the image display device has a display surface and an image calculation unit, the lens array layer is disposed on the display surface of the image display device, and the lens array layer includes a plurality of lens units;
using the image calculation unit to receive a stereoscopic image information, and to create a reference stereoscopic image according to the stereoscopic image information; wherein the reference stereoscopic image is configured to reflect the stereoscopic image that is finally produced;
using the image calculation unit to obtain a viewing angle information according to a viewing angle of a user, and to calculate a plurality of unit images that correspond in position to the plurality of lens units from the reference stereoscopic image according to the viewing angle information; wherein the plurality of unit images are displayed on the display surface of the image display device;
recombining the plurality of unit images into an integral image through the plurality of lens units, so as to finally produce the stereoscopic image;
wherein when the viewing angle of the user changes, the viewing angle information obtained by the image calculation unit will correspondingly change, and the image calculation unit will change display contents of the plurality of unit images according to the changed viewing angle information, so that the finally produced stereoscopic image will be correspondingly changed.

2. The method for displaying the stereoscopic image according to claim 1, wherein when the viewing angle of the user is at a first viewing angle, the viewing angle information obtained by the image calculation unit is defined as a first viewing angle information, and the image calculation unit is configured to calculate a plurality of first unit images from at least a part of contents of the reference stereoscopic image according to the first viewing angle information.

3. The method for displaying the stereoscopic image according to claim 2, wherein when the viewing angle of the user is at a second viewing angle that is different from the first viewing angle, the viewing angle information obtained by the image calculation unit is defined as a second viewing angle information, and the image calculation unit is configured to calculate a plurality of second unit images from at least another part of the contents of the reference stereoscopic image according to the second viewing angle information.

4. The method for displaying the stereoscopic image according to claim 3, wherein the plurality of first unit images and the plurality of second unit images are all displayed on the display surface of the image display device, and the display positions of the plurality of second unit images on the display surface are shifted by a predetermined distance relative to that of the plurality of first unit images; wherein in each of the second unit images and the corresponding first unit image, a display content of the second unit image is different from that of the first unit image.

5. The method for displaying the stereoscopic image according to claim 4, wherein the viewing angle of the user is defined by an angle between a line of sight of the user and a normal vector of the stereoscopic image display apparatus; wherein when the second viewing angle is oblique relative to the first viewing angle, a value of the second viewing angle information will be greater than that of the first viewing angle information, and the positions of the plurality of second unit images on the display surface of the image display device are shifted in a direction away from the user relative to that of the plurality of first unit images.

6. The method for displaying the stereoscopic image according to claim 3, wherein when the viewing angle of the user is at the first viewing angle, the plurality of first unit images calculated by the image calculation unit are further generated by ray tracing, and each of the first unit images has a first ray tracing angle information; wherein when the viewing angle of the user is at the second viewing angle, the plurality of second unit images calculated by the image calculation unit are also generated by the ray tracing, and each of the second unit images has a second ray tracing angle information.

7. The method for displaying the stereoscopic image according to claim 6, wherein the first ray tracing angle information corresponds to the first viewing angle information, the second ray tracing angle information corresponds to the second viewing angle information, and the first ray tracing angle information is different from the second ray tracing angle information.

8. The method for displaying the stereoscopic image according to claim 3, wherein in each of the first unit images and the corresponding second unit image, the first unit image is light converged by one of the lens units among the plurality of lens units, and the second unit image is light converged by the same lens unit as that of the first unit image.

9. The method for displaying the stereoscopic image according to claim 3, wherein the stereoscopic image display apparatus further includes an optical light guide element, the optical light guide element is arranged on a side of the lens array layer away from or adjacent to the image display device, and the optical light guide element is configured to guide light paths of the plurality of first unit images or the plurality of second unit images, so that a first stereoscopic image generated by the plurality of first unit images and a second stereoscopic image generated by the plurality of second unit images are displayed at the same position in a three-dimensional space above the stereoscopic image display apparatus.

10. The method for displaying the stereoscopic image according to claim 9, wherein the plurality of first unit images and the plurality of second unit images are all displayed on the display surface of image display device, and the display positions of the plurality of second unit images on the display surface are the same as the display positions of the plurality of first unit images on the display surface; wherein in each of the second unit images and the corresponding first unit images, the display content of the second unit image is different from the display content of the first unit image.

11. The method for displaying the stereoscopic image according to claim 9, wherein the viewing angle of the user is defined by an angle between a line of sight of the user and a normal vector of the stereoscopic image display apparatus; wherein when the second viewing angle of the user is oblique relative to the first viewing angle, a value of the second viewing angle information will be greater than that of the first viewing angle information, the display positions of the plurality of second unit images on the display surface are the same as the display positions of the plurality of first unit images on the display surface, and the light paths of the plurality of second unit images and the light paths of the plurality of first unit images are all directed toward the plurality of lens units along the normal vector of the stereoscopic image display apparatus; wherein the optical light guide element is configured to deflect the light paths of the plurality of second unit images toward the user.

12. The method for displaying the stereoscopic image according to claim 9, wherein the stereoscopic image display apparatus further includes an eye tracking unit, the eye tracking unit is configured to track the eye position of the user; wherein when the viewing angle of the user is located at a second viewing angle that is different from the first viewing angle, the viewing angle information obtained by the image calculation unit is defined as a second viewing angle information, and the image calculation unit is configured to calculate a plurality of third unit images from at least another part of the contents of the reference stereoscopic image according to the second viewing angle information.

13. The method for displaying the stereoscopic image according to claim 12, wherein the plurality of first unit images and the plurality of third unit images are all displayed on the display surface of the image display device, the positions of the plurality of third unit images on the display surface are shifted relative to the plurality of first unit images; wherein in each of the third unit image and the corresponding first unit image, the display content of the third unit image is different from the display content of the first unit image.

14. A stereoscopic image display apparatus, comprising:
an image display device, the image display device having a display surface and an image calculation unit; and
a lens array layer, the lens array layer being disposed on the display surface of the image display device, and the lens array layer including a plurality of lens units;
wherein the image calculation unit of the image display device is configured to execute the method for displaying the stereoscopic image as described in claim 1.
